(19) United States
(12) Patent Application Publication
(10) Pub. No.: US 2026/0175973 A1
(43) Pub. Date: Jun. 25, 2026

(54) System And Method For Controlling A VTOL Aircraft Using Differing Blade Angle of Attack Regimes With Different Lift Coefficient Curves

(71) Applicant: Joby Aero, Inc., Santa Cruz, CA (US)

(72) Inventors: Gregor Veble Mikic, Santa Cruz, CA (US); JoeBen Bevirt, Santa Cruz, CA (US)

(21) Appl. No.: 19/224,914

(22) Filed: Jun. 2, 2025

Related U.S. Application Data
(60) Provisional application No. 63/738,500, filed on Dec. 23, 2024.

(51) Int. Cl. B64C 29/00; B64C 11/44

(52) U.S. Cl. CPC B64C 29/0033; B64C 11/44; B64C 2220/00

(57) ABSTRACT

A system and method for controlling a VTOL aircraft to minimize acoustic noise. In a hover mode, the aircraft may be controlled to utilize a blade pitch angle and corresponding angle of attack range which minimizes variations in the boundary layer separation location to a point or narrow region, which reduces noise generation. The propeller blades used in the system are configured to have a reduced or no shift of the point of flow separation on the airfoil as a function of angle of attack during the hover mode. The blade design may trade off overall blade efficiency in exchange for the reduced noise during hover.

### TECHNICAL FIELD

This invention relates generally to the aviation field, and more specifically to a flight control system engaging different blade angle of attack regimes in different flight modes.

### BACKGROUND

Aircraft that are propelled by rotating external surfaces, such as rotorcraft and propeller-craft, utilize rotating and often unenclosed blades (e.g., rotary airfoils) to produce thrust. However, rotating blades are a significant source of acoustic noise that is undesirable for aircraft use in several contexts, including urban and suburban environments, in which high noise levels can be disruptive. Noise-based flightpath restrictions can significantly reduce the ability to deploy urban and suburban air mobility systems.

Thus, there is a need in the aviation field to minimize the noise created by rotating blades, especially during hover modes used with VTOL aircraft. This invention provides such a new and useful system and method.

### SUMMARY

A system and method for controlling a VTOL aircraft to minimize acoustic noise. In a hover mode, the aircraft may be controlled to utilize a blade pitch angle and corresponding angle of attack range which minimizes variations in the boundary layer separation location to a point or narrow region, which reduces noise generation. The propeller blades used in the system are configured to have a reduced or no shift of the point of flow separation on the airfoil as a function of angle of attack during the hover mode. The blade design may trade off overall blade efficiency in exchange for the reduced noise during hover.

### BRIEF DESCRIPTIONS OF THE DRAWINGS

FIGS. 1A-B are drawings illustrating aircraft axis.

FIGS. 2A-B are illustrations of an aerial vehicle in a forward flight configuration according to some embodiments of the present invention.

FIGS. 3A-B are illustrations of an aerial vehicle in a hover configuration according to some embodiments of the present invention.

FIG. 4 is a sketch of blade loading for a rotary airfoil.

FIG. 5 is a sketch of airfoil parameters.

FIG. 6 is an illustration of airfoil parameters according to some embodiments of the present invention.

FIG. 7 is a lift coefficient curve for airfoils according to some embodiments of the present invention.

FIG. 8 is a lift coefficient curve for airfoils according to some embodiments of the present invention.

FIG. 9 is a block diagram of a control system according to some embodiments of the present invention.

### DETAILED DESCRIPTION

A vertical take-off and landing (VTOL) aircraft may operate in a number of modes, which may include a hover mode, and transitional mode, and a forward-flight, or cruise, mode. A system according to aspects of the present invention can include a rotor hub to mount a rotary airfoil, a tilt mechanism to pivot the rotary airfoil between a forward configuration and a hover configuration, and a pitching mechanism to change the angle of attack of the rotary airfoil. The change in the angle of attack of the rotary airfoil may be achieved by changing the pitch angle of the rotary airfoil, which may be the blade of a propeller. In some aspects the aircraft may be a tilt-rotor aircraft. In some aspects the aircraft may be a pivot-wing aircraft.

The rotary airfoil functions to generate an aerodynamic force as it is rotated through a fluid (e.g., air), which can be used to propel and/or lift a vehicle (e.g., aircraft). The rotary airfoil can also function to define, at a cross section, a lift coefficient at each angle of attack within a range of angles of attack that reduces and/or minimizes loading variations across the rotor disc of a propeller utilizing two or more rotary airfoils. In some aspects, the rotary airfoil can also function to define a cross section that includes a feature (e.g., a bump) or geometry that localizes a boundary layer separation point along the chordwise direction at a range of angles of attack. In some aspects, the rotary airfoil defines a cross-section that will localize the boundary layer separation point in an angle of attack range used for the hover mode, which may be from 8 to 12 degrees, in an illustrative example.

The system is preferably implemented in conjunction with an aircraft propulsion system (e.g., propeller, rotor, etc.), which in turn is preferably implemented in conjunction with an aircraft. In some aspects, the aircraft is a rotorcraft. The rotorcraft is preferably a tiltrotor aircraft with a plurality of aircraft propulsion systems (e.g., rotor assemblies, rotor systems, etc.), operable between a forward arrangement and a hover arrangement. However, the rotorcraft can alternatively be a pivoting wing aircraft with one or more rotor assemblies or propulsion systems fixedly coupled to the wings. The rotorcraft preferably includes an all-electric powertrain (e.g., battery powered electric motors) to drive the one or more rotor assemblies, but can additionally or alternatively include a hybrid powertrain (e.g., a gas-electric hybrid including an internal-combustion generator), an internal-combustion powertrain (e.g., including a gas-turbine engine, a turboprop engine, etc.), a fuel cell powertrain, and any other suitable powertrain.

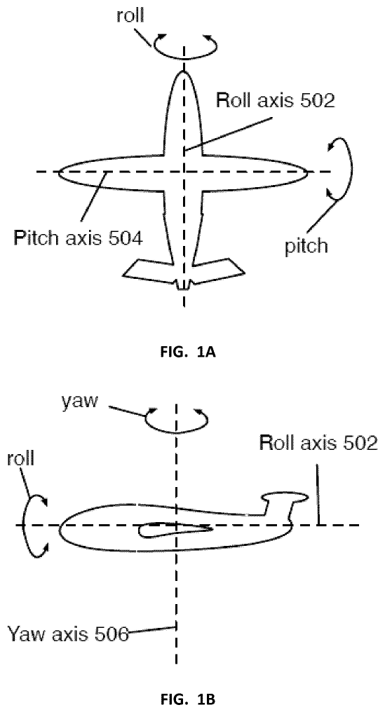

The tiltrotor aircraft defines various geometrical features. The tiltrotor aircraft defines principal geometric axes, as shown in FIGS. 1A-1B, including: a vertical axis (e.g., yaw axis 506), a longitudinal axis (e.g., a roll axis 502), and a lateral axis (e.g., a pitch axis 504). The vertical, longitudinal, and lateral axes can be defined such that they intersect at the center of gravity (CoG) of the aircraft, and a pure moment about any one of the aforementioned axes causes the aircraft 100 to rotate about the vertical, longitudinal, and lateral axes, respectively. However, the three principal axes can additionally or alternatively be defined geometrically (e.g., based on lines of symmetry of the aircraft in one or more dimensions, based on arbitrary lines through the aircraft, etc.) with or without reference to the CoG. For example, the axes can intersect at a geometric center of the aircraft. The propellers of the tiltrotor aircraft each define a disc area centered at the axis of rotation of the propeller, and the disc area is contained by an infinite disc plane extending away from the axis of rotation. In variations of the aircraft, the disc planes of each of the plurality of rotors can be coextensive with any suitable subset of the remainder of the plurality of propulsion assemblies. In a first example, each disc plane can be coextensive with each other disc plane in the hover configuration of a first variation. In a second example, each disc plane can be coextensive with the disc plane of one other propulsion assembly symmetrically across the longitudinal axis of the aircraft and displaced from (e.g., offset from) the disc planes of each other propulsion assembly. However, the disc planes of the plurality of propulsion assemblies can be otherwise suitably arranged relative to one another.

In an illustrative example, the rotary airfoil is integrated into an electric tiltrotor aircraft including a plurality of tiltable rotor assemblies (e.g., six tiltable rotor assemblies), wherein each of the tiltable rotor assemblies includes a rotor that includes a plurality of blades configured according to the blade design described herein. The electric tiltrotor aircraft can operate as a fixed wing aircraft, a rotary-wing aircraft, and in any liminal configuration between a fixed and rotary wing state (e.g., wherein one or more of the plurality of tiltable rotor assemblies is oriented in a partially rotated state). The control system of the electric tiltrotor aircraft in this example can function to command and control the plurality of tiltable rotor assemblies within and/or between the fixed wing arrangement and the rotary-wing arrangement.

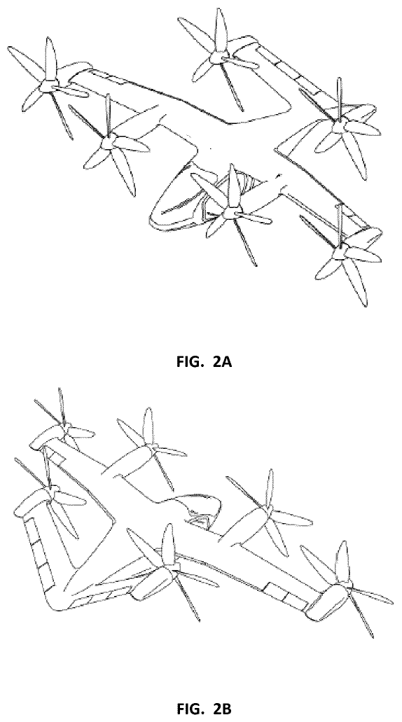

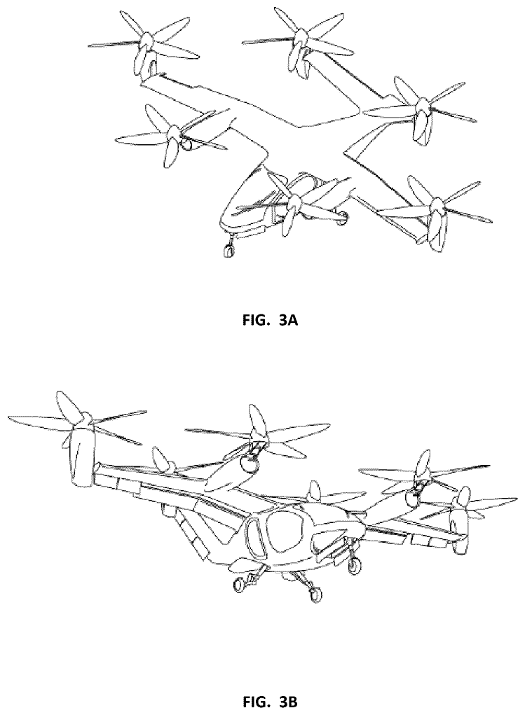

In an illustrative example, as shown in FIGS. 2A-B in a forward-flight configuration, and as shown in FIGS. 3A-B in a hover configuration, the tiltrotor aircraft 300 includes six propulsion assemblies. In this example, a first propulsion assembly is coupled to a left outboard location on the wing (e.g., at the wingtip) by a pivot, a second propulsion assembly is coupled to a right outboard location on the wing by a pivot, a third propulsion assembly is coupled to an inboard region of the wing on the left side and includes a forward-extension linkage, a fourth propulsion assembly is coupled to an inboard region of the wing on the right side and includes a forward-extension linkage, a fifth propulsion assembly is coupled to a left side of the empennage and includes a pivot, and a sixth propulsion assembly is coupled to a right side of the empennage and includes a pivot.

Each propulsion assembly includes: an electric motor, a propeller coupled to the electric motor, and a tilt mechanism that connects the propulsion assembly to the airframe and transforms the propulsion assembly between a forward configuration and a hover configuration. Each propeller defines a disc area, a hub at a center of the disc area, and a disc plane containing the disc area (e.g., and extending away from the hub). Each propulsion assembly 120 is operable between a forward configuration and a hover configuration, wherein the disc plane is perpendicular to the roll axis 20 in the forward configuration, and wherein the disc plane is perpendicular to the yaw axis 10 in the hover configuration.

The aircraft is further configured to include a control system adapted to control aspects of the propulsion assemblies during hover, during transition, and during forward flight. With regard to forward flight, the control system may control the aircraft by the alteration and control of the rpm of the motors of each of the propulsion assemblies, as well as the angle of attack of the blades of each propeller, which will be controlled by controlling the blade pitch angle. In an illustrative example, the angle of the attack of the propellers may vary in the range of −5 to 5 degrees while in the forward flight mode. By controlling the rpm of the motors and the blade pitch angle, the control system may then control the speed of the aircraft and the aircraft attitude. For example, to pitch up the aircraft, the control system may increase the thrust of the propulsion assemblies which are mounted lower in elevation relative to the propulsion assemblies which are mounted higher in elevation. In some aspects, the control system may control the aircraft solely by altering the motor speeds and the blade pitch angles, without the need to use other controllable control surfaces. In some aspects, the aircraft may have no other controllable control surfaces. In some aspects, the aircraft may have other controllable control surfaces, and the control system will be configured to control the controllable control surfaces.

The aircraft may use a different angle of attack regime for the rotary airfoils, which results from controlling the blade pitch angle during hover operations. During hover operations, the angle of attack of the blades and the blade pitch angle may be in a higher range than during forward flight operations. In an illustrative example, the angle of attack of the propeller blades may be in the range of 8 degrees to 12 degrees. The control system in configured to control the angle of attack of the propeller blades to be within this range during hover operations. Other considerations may come into play when controlling the aircraft during hover operations. For example, it may be desired to operate the motors of the different propulsion assemblies at offset rotational speeds in order to reduce the acoustic output of the aircraft during hover when operating in the vicinity of people. Simultaneous variation of the motor rotational speeds of the different propulsion assemblies may reduce the psychoacoustic penalty of the sound emitted by the aircraft. However, additional features of the system may also reduce the psychoacoustic penalty of the sound emitted by the aircraft.

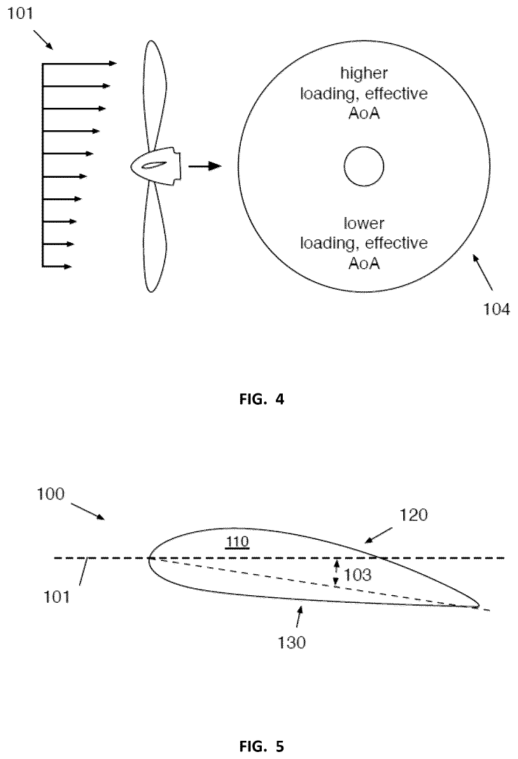

Conventional optimization of airfoil shapes to enhance aerodynamic efficiency can have adverse and counterintuitive effects on the acoustic performance of the airfoil and/or propellers utilizing a plurality of rotary airfoils (e.g., propeller blades). This can be caused by inflow conditions varying across the rotor disc (e.g., as shown in FIG. 4), which in turn causes each blade to experience different inflow conditions (e.g., effective angles of attack) and thus produce different aerodynamic forces; the disc loading is thus asymmetric/uneven. The magnitude of loading asymmetry/unevenness can be proportional to the magnitude of undesirable acoustic output, and more efficient airfoils (e.g., defining a steeper lift coefficient curve) can exacerbate the loading asymmetry/unevenness.

Thus, it may be desired to utilize inefficient airfoil design for the blade such that the lift coefficient curve is shallower to reduce the impact of inflow condition variations across a rotor disc, as may be present during hover operations. As may be expected, it is also during hover that impacts from undesirable acoustic output are most desired to be avoided, as hover may occur over populated areas, and near people on the ground. As the aircraft and system may use a separate angle of attack regime for hover operations, the airfoil for the blade may be designed so that the shallower lift coefficient curve is only present for the higher angles of attack associated with the hover angle of attack range.

A control system and method to address these concerns will then operate the blades within the hover angle of attack range during hover. In some aspects, the control system may also control the rotational speed of the propulsion assemblies to offset the motor speeds from each other in order to reduce the acoustic penalty, while operating within the hover angle of attack ranges which have a shallower lift coefficient curve in order to reduce undesirable acoustic output resulting from loading asymmetry.

Conventionally, aircraft operation in hover mode presents larger inflow variations due to ground effects (“dirty air”) which correspond to an increase in the noise profile due to loading asymmetry/unevenness. Because hover modes may be used near human-populated regions where it is most critical to reduce the noise profile to meet regulatory requirements and improve user experience, the acoustic profile conferred by variants of this design can be particularly desirable for hover mode operation in human- or civilian-facing applications. In such variations, the rotary airfoil incurs an efficiency penalty (e.g., ˜3%) in order to improve the acoustic performance during hover (e.g., during operation in the hover angle of attack range), where the lift coefficient curve has a shallower slope than the lift coefficient curve in the forward angle of attack range. This can result in minimizing the loading asymmetry/unevenness resulting from inflow variation, at the cost of increased drag. This effect can have compounding positive effects when combined with conventional means of improving the acoustic performance of a rotary airfoil, such as: tapering the blade along the length, twisting the blade to change the pitch angle along the length, angling the blade tip (e.g., anhedral angle, dihedral angle), optimizing the airfoil cross section for different Reynold's number ranges on different portions of the blade (e.g., lower Re on inner portion and higher Re on outer portion), and/or other conventional approaches to rotor to noise reduction. However, in such variations the rotary airfoil does not incur a significant efficiency penalty in forward flight-which represents a majority of aircraft operation. By operating in a forward angle of attack range during forward flight, high propulsive efficiency can minimize the cost of fuel and/or electricity supplied to the aircraft, minimize the number of refueling/recharging stops, reduce vehicle weight of energy storage systems, and/or improve the aircraft range.

Although the blade will be designed such that the angle of attack of the blade is held as close to constant along the span of the blade, using twist and tapering as discussed above, the angle of attack for the blade as controlled by the control system shall be an idealized angle of attack for the blade. In some aspects, the angle of attack for the blade shall be the angle of attack as calculated for the blade at a point along the span of the airfoil 75% out from the spin axis. In some aspects, the angle of attack for the blade shall be the angle of attack as calculated as an average angle of attack along the span, or along a pre-determined range along the span.

In some aspects, as seen in FIG. 5, the rotary airfoil 100 defines a cross section and a span, wherein the cross section 110 is a function of the point along the span (e.g., spanwise point) and defines an upper surface 120 and a lower surface 130 at each spanwise point. The rotary airfoil 100 also defines, at a cross section, a lift coefficient (C_{L}) that is a function of the angle of attack at which the airfoil is rotated through the air. However, the rotary airfoil 100 can additionally or alternatively include or define any other suitable components or features.

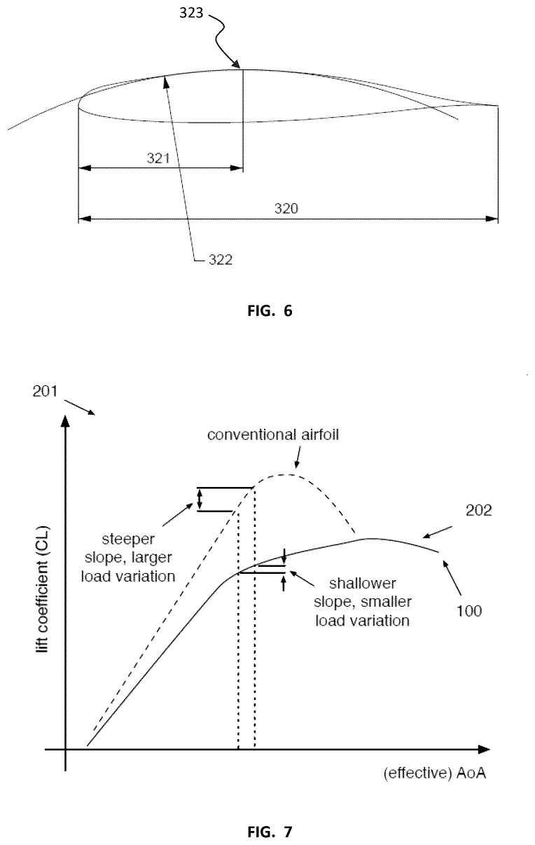

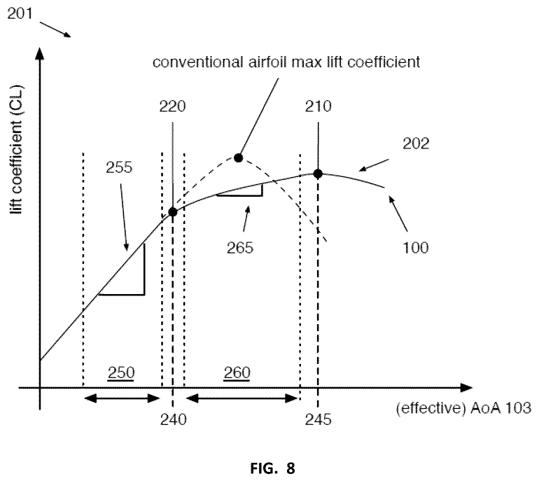

A rotary airfoil design which provides a steeper coefficient of lift curve in a forward-flight angle of attack regime and a shallower coefficient of lift curve in a hover angle of attack regime, as illustrated in FIG. 8, is seen in cross-sectional side view in FIG. 6. The chord length 320 represents a normalized length for reference for the chord position 321 of a high point 323 of the airfoil, and a radius 322 represents the radius of the upper surface of the airfoil at that high point 323. The high point 323 is a raised feature, which may be viewed as a bump, although it may be a subtle bump. The airfoils can include a raised feature (e.g., a bump) along the upper surface (e.g., forward of the chordwise midpoint), followed by a downward taper, that localizes the boundary layer separation point relative to the raised feature as angle of attack is increased. In an illustrative example of an airfoil design with a shallower lift coefficient curve at a hover angle of attack range, which may be 8 degrees to 12 degrees, the high point 323 resides at a chord position 321 that is 39% of the chord length 320. The radius of curvature at the high point 323, representing the raised feature, is 117% of the chord length 320. In some aspects, the high point 323 resides at a chord position in the range of 38-40% of the chord length 320. In some aspects, the radius of curvature at the high point is in the range of 115 to 119% of the chord length 320. The mean camber line of the trailing edge of the airfoil slopes downward. The airfoil blade comprises a first airfoil cross section, the first airfoil cross section defining: a chord line defining a chord length L; a leading edge, comprising a leading edge radius between 0.002 L and 0.05 L; a trailing edge, comprising a trailing edge thickness between zero and 0.03 L; a maximum thickness between 0.07 L and 0.2 L and located between 0.2 L and 0.6 L along the chord line; and a maximum camber between 0 and 0.2 L and located between 0.2 L and 0.7 L along the chord line.

FIG. 7 illustrates lift coefficient curves and variation with angle of attack for a rotary airfoil as discussed above, and as seen in FIG. 6. A conventional airfoil without the change in slope of the lift coefficient curve as a function of angle of attack is also illustrated. The lift coefficient curve can define more than one slope. Slopes for the coefficient of lift curve can be determined as: the derivative of the coefficient of lift curve at a particular angle of attack (e.g., of a function approximating the curve), by the slope formula (change in lift coefficient over change in angle of attack), or otherwise calculated. The slope formula can be applied over any appropriate step size. The step can be for the angle of attack: a single degree change in angle of attack, a range across the angle of attack (e.g., first angle of attack range, second angle of attack range), a fraction of a range across the angle of attack (e.g., ¼ of the second angle of attack range), a fixed step size in the lift coefficient (e.g., for a 0.1 change in the lift coefficient), and/or otherwise calculated. The slope of the lift coefficient can further define a rate of change of the slope, using the same, similar, or different technique as the slope calculation. The rate of change of the slope of the lift coefficient curve can be determined as the second derivative, across part of a region as a change between two steps of the slope curve (which can be overlapping or non-overlapping), across an entire region of the lift coefficient curve, or otherwise calculated. The rate of change of the slope of the lift coefficient curve can be determined as a statistical deviation from a line or curve, evaluating the curvature of the lift coefficient curve (minimum curvature, maximum curvature, and/or average curvature), and/or otherwise determined.

The variation of lift coefficient with angle of attack of the rotary airfoil also preferably exhibits shallow roll-off after the stall point in comparison with a different airfoil shape. This can function to prevent large load discrepancies between blades from developing when all or part of one or more blades is in a localized stall condition. This can also function to prevent rapid loss of propulsive power (or lift force) when all or part of one or more rotary airfoils is in a localized stall condition.

The shallow slope of the lift coefficient in the desired angular region of the lift coefficient curve 201 can function to provide a psychoacoustic benefit during operation of a propeller utilizing two or more of the rotary airfoils defined by such a lift coefficient curve. The lift coefficient curve preferably defines a max CL point 210 (corresponding to maximum lift) at a critical angle of attack 245. Below the critical angle of attack, the lift coefficient curve preferably defines a semi-critical angle of attack, corresponding to the onset of flow separation at the semi-critical flow separation point 220 on the upper surface of the airfoil.

Below the semi-critical angle of attack, the airfoil operates in a first angle of attack range 250 (e.g., forward range). The lift coefficient curve defines a linear (or near-linear) regime within first angle of attack range, corresponding to attached flow over the upper surface of the airfoil. The first angle of attack range has sufficient width such that variable inflow over the rotor disc area does not result in significant pressure drag or inefficiencies. In an illustrative example, the first angle of attack range has a width of 10 degrees. The first angle of attack range may be from −5 to 5 degrees.

Above the semi-critical angle of attack and below the critical angle of attack, the airfoil operates in a second angle of attack range 260 (e.g., hover range). The second angle of attack range preferably has a shallower slope of the lift coefficient curve than the first angle of attack range, and corresponds to separated flow over the upper surface of the airfoil between the semi-critical separation point and the trailing edge, but can alternatively have a steeper or the same slope as the first angle of attack range. The second angle of attack range can have a smaller, larger, or the same width as the first angle of attack range. The second angle of attack range is preferably separate and distinct from the first angle of attack range. The second angle of attack range may have a width of 4 degrees. In some aspects, the second angle of attack range is from 8 degrees to 12 degrees angle of attack. In some aspects, the second angle of attack range is from 8 to 10 degrees angle of attack.

In a first example the airfoil blade comprises a first airfoil cross section, the first airfoil cross section defining: a chord line defining a chord length L; a leading edge, comprising a leading edge radius between 0.002 L and 0.05 L; a trailing edge, comprising a trailing edge thickness between zero and 0.03 L; a maximum thickness between 0.07 L and 0.2 L and located between 0.2 L and 0.6 L along the chord line; and a maximum camber between 0 and 0.2 L and located between 0.2 L and 0.7 L along the chord line.

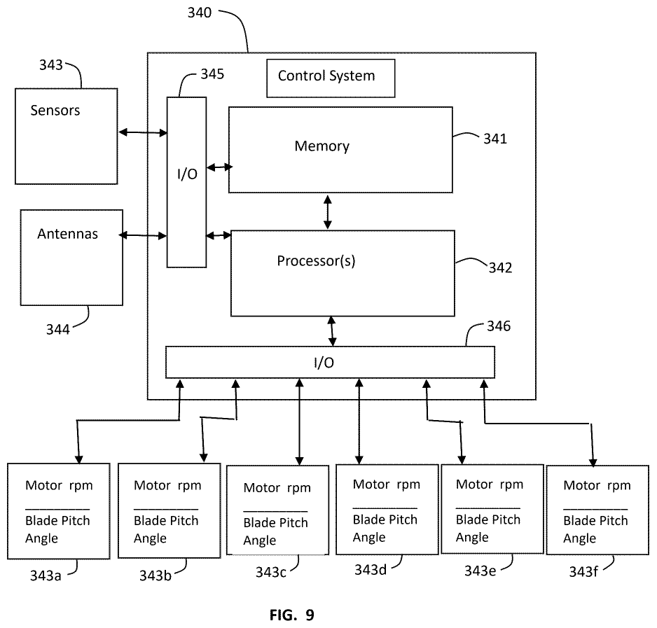

FIG. 9 illustrates a block diagram of a control system 340 according to some embodiments of the present invention. The control system 340 may have a memory block 341 and a processor block 342, which may comprise one or more processors. Aircraft sensors 343 may couple to the control system through an input/output interface 345. The aircraft may be in communicative contact with ground stations or other aircraft via an antenna 344. The control system determines the motor rotational speeds and the blade pitch angle for each of the propulsion assemblies. The propulsion assemblies are coupled to the control system through an input/output interface 346. In this illustrative embodiment, there are six propulsion assemblies 347a-f, each with a motor and a blade pitch control mechanism.

In some aspects, a method for controlling an aircraft with propulsion assemblies having rotary airfoils which have a lift coefficient curve with a first slope in a first angle of attack range, and a second slope in a second angle of attack range. The method includes using a control system which controls the rpms of the motors of the propulsion assemblies, and which also controls the blade pitch angle and the angle of attack of the rotary airfoils of the propulsion assemblies. The control system prioritizes use of the first angle of attack range during forward flight (cruise) operation, and prioritizes the second angle of attack range during hover operations, as used during vertical take-off and landing. During cruise/forward-flight operation, the control system prioritizes the angle of attack range over the motor rotational speed, such that in order to maintain the desired thrust distribution the angle of attack of the rotary airfoil(s) remains within the first angle of attack range. In this range, the lift coefficient curve is steeper than in the second angle of attack range. Should more thrust be needed than can be provided within the first angle of attack range, the motor rotational speed would be adjusted rather than increasing the angle of attack of the rotary airfoil outside the first range.

Similarly, for hover operation, the control system prioritizes the angle of attack range over the motor rotational speed, such that in order to maintain the desired thrust distribution the angle of attack of the rotary airfoil(s) remains in the second angle of attack range. In an illustrative example, the first angle of attack range is −5 to +5 degrees. In some aspects the first angle of attack range is −2 to +6 degrees. In an illustrative example, the second angle of attack range is +8 to +12 degrees. In some aspects the second angle of attack range is +8 to +10 degrees. The control system may also maintain a spread of rotational speeds of the rotary airfoils to further reduce the acoustic penalty of the propulsion assemblies.

The angle of attack of the blade of a rotary airfoil is affected by the blade pitch angle and the rpm of the rotary airfoil. The angle of attack of the blade is a function of airflow aspects through the blade disc and is not solely a function of the blade pitch angle relative to the rotor hub. The airspeed of the aerial vehicle will also be a factor in the determination of the angle of attack of the blade, especially in the forward flight mode. A blade used in systems according to embodiments of the present invention will be able to have the angle of attack of the blade calculated for different flight scenarios. For example, the airspeed of the aerial vehicle may be determined using sensors. In some aspects, the airspeed may be determined using sensors which directly sense air pressures or other characteristics of the airflow around the aircraft. In some aspects, the airspeed may be determined using determinations based upon other methods involving determinations based upon rotor loadings and rpms. With the physical characteristics of the blades understood in advance, the control system is able to set an angle of attack for the blades by adjusting the blade pitch angle and/or the motor rpms. Thus, the control system is able to maintain the angle of attack of the blades for a given operational scenario. The blade pitch angle is defined and the blade pitch angle relative to the rotor hub. In some aspects, the memory of the control system will contain a database which correlates the blade pitch angle and rpms of the rotor, along with the airspeed, to arrive at an appropriate pitch angle of the blade to provide the desired angle of attack. In this way, the control system can control the angle of attack of the blades to remain within an angle of attack range during hover operations, for example. The control system can prioritize the control of the system such that blade pitch angle and motor rpm are varied to keep the angle of attack of the blade within the desired range. The prioritization of the angle of attack over other parameters, such as motor rpm or blade pitch angle, allows the control system to keep the angle of the attack within a desired range. For example, in hover mode, the desired angle of attack range may be 8 degrees to 12 degrees, in order to have the blades operate in a regime where the blades have a shallower slope of the lift coefficient curve, and in a regime which localizes a boundary layer separation point along the chordwise direction, which will result in a lower acoustic penalty. In some aspects, the control system will have an accessible database in its memory which provides the angle of attack of the blade relative to the rotor rpm and the blade pitch angle. Using an illustrative example of the hover mode, the aerial vehicle will be hovering with each of the six rotors in a substantially vertical orientation. In order to perform a desired operation, such as to gain elevation, the control system will determine a thrust distribution for the vehicle. The control system will then control each rotor assembly to provide the amount of thrust determined as needed for that rotor assembly. When functioning in a mode wherein the angle of attack range is desired to be kept in certain range, such as when near any area where noise is desired to be kept to a minimum, the control system will control the rotors to remain within the desired angle of attack range for the blades, which may be 8-12 degrees in some aspects. The rotor rotational speed will be adjusted such that the angle of attack of the blades remains in the desired range. In some aspects, the control system will override the command to keep the blades in the desired angle of attack range, such as when the aircraft attitude has deviated further from a desired attitude than allowed, which may change the priority from noise to safety, for example.

In some embodiments of the present invention, a method of thrust control of a vertical take-off and landing aircraft comprises the steps of tilting a propeller having a plurality of blades with variable pitch, the propeller being configured to tilt to a vertical orientation for hover flight mode and a horizontal orientation for forward flight mode; rotating the propeller to generate thrust; and controlling the variable pitch propeller to operate within different pitch regimes in the hover and forward flight modes, the pitch regime for the forward flight mode corresponding to a first angle of attack range and the pitch regime for the hover flight mode corresponding to a second angle of attack range. The angle of attack range for the forward flight mode may be less than the angle of attack in the hover mode. The lift coefficient curve for the second angle of attack range may be shallower than the lift coefficient curve for the first angle of attack range. In some aspects, the first angle of attack range and the second angle of attack range do not overlap.

As a person skilled in the art will recognize from the previous detailed description and from the figures and claims, modifications and changes can be made to the preferred embodiments of the invention without departing from the scope of this invention defined in the following claims.

1. A method of thrust control of a vertical takeoff and landing aircraft, the method comprising:
tilting a propeller having a plurality of blades with variable pitch, the propeller being configured to tilt to a vertical orientation for hover flight mode and a horizontal orientation for forward flight mode;
rotating the propeller to generate thrust; and
controlling the variable pitch propeller to operate within different pitch regimes in the hover and forward flight modes, the pitch regime for the forward flight mode corresponding to a first angle of attack range and the pitch regime for the hover flight mode corresponding to a second angle of attack range.

2. The method of claim 1, wherein the angle of attack range for forward flight mode is less than the angle of attack range for hover flight mode.

3. The method of claim 1, wherein each of the plurality of blades is characterized by a lift coefficient curve having a shallower curve for a second angle of attack range than the lift coefficient curve for a first angle of attack range, and wherein the pitch regime for the hover flight mode corresponding to the second angle of attack range and the pitch regime for the forward flight mode corresponding to the first angle of attack range.

4. The method of claim 1 wherein the first angle of attack range and the second angle of attack range do not overlap.

5. The method of claim 2 wherein the first angle of attack range and the second angle of attack range do not overlap.

6. The method of claim 3 wherein the first angle of attack range and the second angle of attack range do not overlap.

7. The method of claim 6 wherein the first angle of attack range has a minimum of −5 degrees and a maximum of 5 degrees, and wherein the second angle of attack range has a minimum of 8 degrees and a maximum of 10 degrees.

8. The method of claim 1 wherein the slope of the lift coefficient curve of the blades in the first AOA range is in the range of 0.25 to 0.75 times the slope of the lift coefficient curve of the blades in the second AoA range.

9. The method of claim 1 wherein the slope of the lift coefficient curve of the blades in the first AOA range is in the range of 0.25 to 0.50 times the slope of the lift coefficient curve of the blades in the second AoA range.

10. The method of claim 1 wherein said blades comprise an airfoil profile of chord length L with a high point located between 38-40% along the chord line, and wherein the radius of curvature at the high point is in the range 115 to 119% of L.

11. The method of claim 10 wherein said blades further comprise:
a leading edge comprising a lead edge radius between 0.002 L and 0.05 L;
a trailing edge comprising a thickness between zero and 0.03 L;
a maximum thickness between 0.07 L and 0.2 L located between 0.2 L and 0.6 L along the chord line; and
a maximum camber between 0 and 0.2 L located between 0.2 L and 0.7 L along the chord line.

12. A control system for the thrust control of a vertical take-off and landing aircraft, the control system comprising:
a processor; and
a memory module,
wherein said processor is configured to control a plurality of propulsion assemblies to provide a thrust distribution around the aircraft by controlling the rotational speed and the blade pitch angle of the propulsion assemblies while maintaining the angle of attack of the blades of the propulsion assemblies within desired ranges.

13. The control system of claim 12 wherein said processor is configures to maintain the angle of attack of the blades of the propulsion assemblies within a range of 8-12 degrees while the aircraft is in a hover mode.

14. The control system of claim 13 wherein said blades comprise an airfoil profile of chord length L with a high point located between 38-40% along the chord line, and wherein the radius of curvature at the high point is in the range 115 to 119% of L.

15. The control system of claim 14 wherein said blades further comprise:
a leading edge comprising a lead edge radius between 0.002 L and 0.05 L;
a trailing edge comprising a thickness between zero and 0.03 L;
a maximum thickness between 0.07 L and 0.2 L located between 0.2 L and 0.6 L along the chord line; and
a maximum camber between 0 and 0.2 L located between 0.2 L and 0.7 L along the chord line.

16. A rotary airfoil blade, said blade comprising a first airfoil cross section, the first airfoil cross section defining:
a chord line defining a chord length L;
a leading edge, comprising a leading edge radius between 0.002 L and 0.05 L;
a trailing edge, comprising a trailing edge thickness between zero and 0.03 L;
a maximum thickness between 0.07 L and 0.2 L and located between 0.2 L and 0.6 L along the chord line; and
a maximum camber between 0 and 0.2 L and located between 0.2 L and 0.7 L along the chord line,
wherein said cross section has a raised feature on the top surface of the airfoil at a point 38-40% of L, with a radius of curvature of 115-119% of L, and wherein the mean camber line of the trailing edge slopes downward.

17. An apparatus of a vertical takeoff and landing aircraft, the apparatus comprising:
a flight control system configured to command and control a tiltable rotor assembly by performing one of more actions, the actions comprising:
tilting a propeller having a plurality of blades with variable pitch, the propeller being configured to tilt to a vertical orientation for hover flight mode and a horizontal orientation for forward flight mode;
rotating the propeller to generate thrust; and
controlling the variable pitch propeller to operate within different pitch regimes in the hover and forward flight modes, the pitch regime for the forward flight mode corresponding to a first angle of attack range and the pitch regime for the hover flight mode corresponding to a second angle of attack range.

18. The apparatus of claim 17 wherein said blades comprise an airfoil profile of chord length L with a high point located between 38-40% along the chord line, and wherein the radius of curvature at the high point is in the range 115 to 119% of L.

19. The control system of claim 18 wherein said blades further comprise:
a leading edge comprising a lead edge radius between 0.002 L and 0.05 L;
a trailing edge comprising a thickness between zero and 0.03 L;
a maximum thickness between 0.07 L and 0.2 L located between 0.2 L and 0.6 L along the chord line; and
a maximum camber between 0 and 0.2 L located between 0.2 L and 0.7 L along the chord line.
